(19) United States
(12) Patent Application Publication
(10) Pub. No.: US 2006/0072760 A1
(43) Pub. Date: Apr. 6, 2006

(54) System and method to use a wireless network to protect data and equipment

(76) Inventor: Frank Gates, (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/954,506

(22) Filed: Sep. 29, 2004

(51) Int. Cl. H04K 1/00

(52) U.S. Cl. 380/270

(57) ABSTRACT

Preventing the misappropriation of high-value equipment or confidential data by providing access to the equipment or data only after finding and connecting to a predetermined wireless network. If the predetermined wireless network cannot be located, or if a connection to the predetermined wireless network cannot be established, the high-value equipment becomes inoperable or access to the confidential data is restricted. The confidential data may also be deleted to prevent misappropriation.

### BACKGROUND

Companies or individuals often store highly sensitive or confidential information on hardware devices such as computers or servers. This information can include data such as medical records, financial records, credit card numbers, human resources records, personnel records, research and development data, as well as any other information to which an individual or an entity desires to restrict access. The computers or other hardware that this sensitive information is stored on can often include mobile assets such as laptop computers, notebook computers, personal digital assistants (PDAs), and mobile telephones.

The portability of mobile assets provides employees with the freedom to easily move around within an office or other work area. Unfortunately, this portability also makes mobile assets an easy target for theft. And because mobile assets are easily removed, a visitor to the office, an unscrupulous employee, a contractor, or any other person within the office or work area will have opportunities to misappropriate such assets along with any sensitive information contained therein. Additionally, high-value equipment such as desktop computers, servers, and laboratory equipment such as logic analyzers are subject to theft simply because they are expensive and a market exists for such devices after they are stolen.

One method for preventing the misappropriation of hardware containing sensitive information is posting security guards at work area exits. The security guards can visually inspect employees, visitors, and others for hardware as they exit. If a person has a mobile asset, the security guard can verify that he or she is authorized to remove the mobile asset from the work area. The security guards can also perform searches on people as they exit to check for mobile assets that are not readily visible. These techniques of visual inspections and searches are ineffective at best, are very time-consuming, and realistically provide little in the way of loss prevention.

### BRIEF DESCRIPTION OF THE DRAWINGS

FIGS. 1A to 1D show various hardware devices that can be secured using some implementations of the invention.

FIG. 2 illustrates a trusted zone according to an implementation of the invention.

FIG. 3 is a method for securing a hardware device on start-up in accordance with an implementation of the invention.

FIG. 4 is a method for securing a hardware device during operation in accordance with an implementation of the invention.

### DETAILED DESCRIPTION

Described herein are implementations of systems and methods to secure sensitive or confidential information stored on hardware devices that may include some form of wireless access. In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

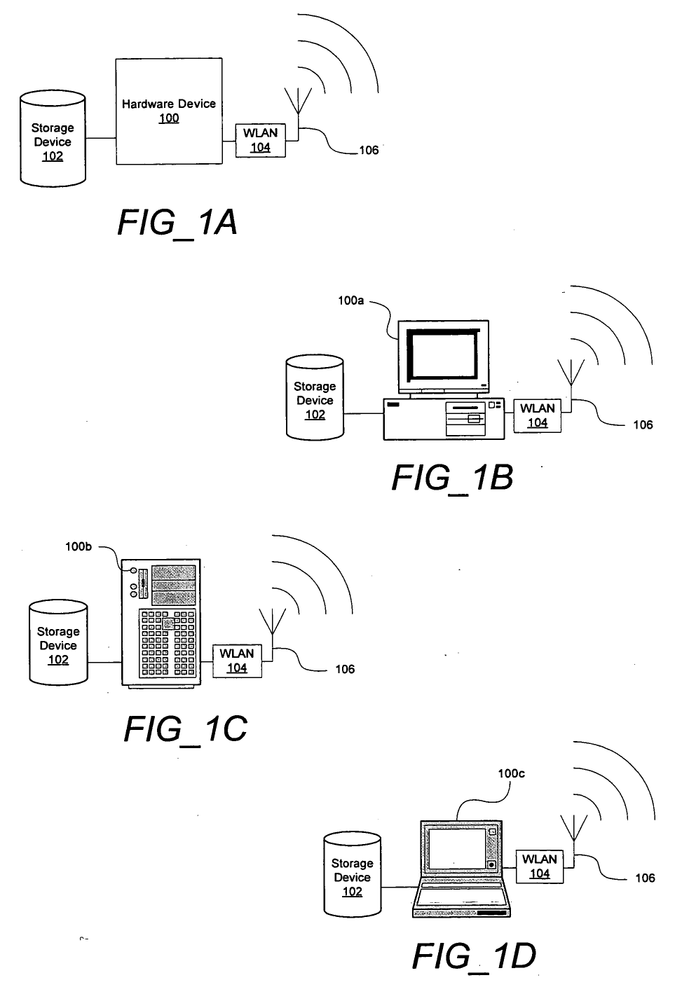

FIG. 1A illustrates an implementation of a hardware device 100 in accordance with the invention. The hardware device 100 may be a system that is capable of processing and accessing data. Examples of hardware devices 100 may include, but are not limited to, computer systems, oscilloscopes, in-circuit emulators, device programmers, and other data processing systems. In some implementations, the hardware device 100 may include at least one processor and memory (not shown) to carry out the methods of the invention described herein.

The hardware device 100 may include a storage device 102. Confidential or sensitive data may be stored within the storage device 102. In some implementations, the storage device 102 may be physically located within the hardware device 102 (it should be noted that the storage device 102 is shown external to the hardware device 100 in FIG. 1A for clarity). In other implementations, the storage device 102 may be housed external to the hardware device 100. Examples of the storage device 102 may include, but are not limited to, hard disk drives, floppy disk drives, magnetic tape drives, other magnetic media drives, compact disc (CD) drives, digital video disc (DVD) drives, other optical media drives, magneto-optical drives, flash memory, electrically erasable programmable read-only memory (EEPROM), other electronic media, and any other memory and storage apparatuses that can be used in conjunction with a computer system or another data processing system.

The hardware device 100 may further include a wireless device, such as a wireless card 104, to receive wireless communications. The wireless device may also transmit wireless communications. As is well known in the art, in some implementations the wireless card 104 may be a Peripheral Component Interconnect (PCI) type wireless card that is located within the hardware device 100, a mini-PCI type wireless card that is located within the hardware device 100, or a Personal Computer Memory Card International Association (PCMCIA) card that can be inserted into the hardware device 100. In some implementations, alternate wireless devices may be used including devices that can be coupled to the hardware device 100 by, for instance, a Universal Serial Bus (USB) port.

The wireless card 104 may include an antenna 106 that may be located within the wireless card 104 (not shown) or external to the wireless card 104 (as shown in FIG. 1). Furthermore, the antenna 106 may be located within the hardware device 100 (e.g., as a mini-PCI type wireless card would use) or external to the hardware device 100 (e.g., as a PCMCIA card or a PCI card would use). The wireless card 104 generally uses the antenna 106 for receiving and transmitting wireless signals.

The wireless card 104 may or may not be available to users of the hardware device 100. For instance, in some implementations, the sole purpose of the wireless card 104 may be to carry out the methods of the invention described herein. Users of the hardware device 100 may not be aware that the hardware device 100 includes the wireless card 104. In some implementations, the wireless card 104 may be used actively for wireless communications, and a user of the hardware device 100 may be fully aware that the hardware device 100 includes the wireless card 104.

As will be well-known to those of ordinary skill in the art, the wireless card 104 enables the hardware device 100 to connect to a wireless local-area network (WLAN). A wireless access point (AP) may be used to both establish the WLAN and to broadcast an identifier for the WLAN. In one implementation, this broadcast identifier may be a service set identifier (SSID). In some implementations the AP may make its SSID visible to all hardware devices 100 within range; in other implementations the AP may hide its SSID and allow only hardware devices 100 that already know the SSID to connect to the AP.

The hardware device 100 may detect the presence of a WLAN by using the wireless card 104 to capture and read the broadcast identifier for the WLAN (e.g., the SSID). The hardware device 100 may join the WLAN by connecting to the AP associated with the WLAN. The wireless card 104 therefore facilitates wireless communications between the hardware device 100 and the AP. The wireless card 104 may use radio frequency (RF) technology to receive and transmit data wirelessly.

FIGS. 1B to 1D illustrate some implementations of the hardware device 100. It should be noted that although some implementations are described herein, many other implementations are possible. FIG. 1B shows an implementation where the hardware device 100 is a desktop computer 100a. FIG. 1C shows the hardware device 100 as a network server 100b. And FIG. 1D shows the hardware device 100 as a laptop computer 100c.

Each of the desktop computer 100a, the network server 100b, and the laptop computer 100c may include the storage device 102 for storing confidential or sensitive data. In implementations of the invention, the storage device 102 may be housed either internal or external to its corresponding hardware device 100. Each of the desktop computer 100a, the network server 100b, and the laptop computer 100c may also include the wireless card 104 and the antenna 106. Again, these devices may be housed internal or external to their corresponding hardware device 100.

In some implementations of the invention, the hardware device 100 may be alternate devices, including but not limited to notebook computers, personal digital assistants (PDAs), and other hardware devices that may store sensitive or confidential data. In some implementations, the hardware device 100 may include high value equipment for which there is an after-theft market, such as logic analyzers, oscilloscopes, in-circuit emulators, and device programmers. The invention may be used to deter the theft of high value equipment regardless of whether or not the equipment contains sensitive or confidential data. The high value equipment may not include the storage device 102.

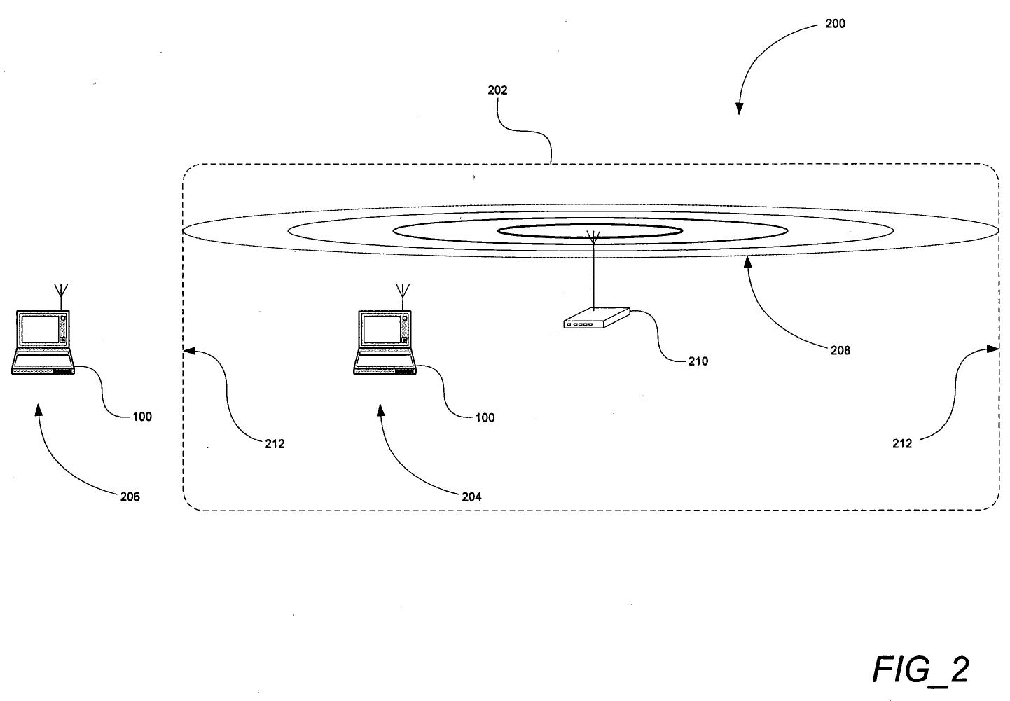

FIG. 2 illustrates one implementation of a trusted zone 202 for protecting sensitive and confidential data on the hardware device 100, as well as the hardware device 100 itself. When the hardware device 100 is located within the trusted zone 202, as shown by reference numeral 204, the hardware device 100 is fully functional with little to no restrictions on access to its data. Any sensitive or confidential data stored on the storage device 102 may be fully accessible while the hardware device 100 is within the trusted zone 202. As such, the hardware device 100 may be used as it normally would in the absence of the trusted zone 202.

When the hardware device 100 is located outside of the trusted zone 202, as shown by reference numeral 206, any data stored on the storage device 102 may become at least partially inaccessible. For instance, access to sensitive or confidential data stored on the hardware device 100 may become restricted or denied. In further implementations, when the hardware device 100 is located outside of the trusted zone 202, the hardware device 100 itself may become at least partially inoperable. This is described in more detail below.

In accordance with the invention, a trusted WLAN 208 is a wireless network that defines the trusted zone 202 for the purpose of securing the hardware device 100. The hardware device 100 may be configured to detect and connect to the trusted WLAN 208 before allowing users to access confidential or sensitive data. If the hardware device 100 cannot detect the presence of the trusted WLAN 208, or if the hardware device 100 cannot connect to the trusted WLAN 208, the hardware device 100 may restrict or deny access to its data.

An identifier for the trusted WLAN 208, such as an SSID, is provided to the hardware device 100 to enable the hardware device 100 to recognize the trusted WLAN 208 when it is detected. In one implementation, the identifier for the trusted WLAN 208 may be stored on the storage device 102 of the hardware device 100. In another implementation, the identifier for the trusted WLAN 208 may be stored in electronic media within the hardware device 100, such as a flash memory or an EEPROM.

In an implementation of the invention, a trusted access point (AP) 210 may establish the trusted WLAN 208 using wireless signals, for instance, RF signals. The trusted AP 210 may also broadcast the SSID or other identifier for the trusted WLAN 208. This broadcast may be either visible to or hidden from all of the hardware devices 100 within range of the trusted AP 210. If the broadcast identifier is hidden, only hardware devices 100 that have previously stored the identifier may detect the trusted AP 210. In some implementations, wireless routers configured as APs may be used as the trusted AP 210.

The size of the trusted zone 202 is generally defined by the wireless range of the trusted AP 210. As is known in the art, the wireless range of the trusted AP 210 is represented by the distance of a furthest point 212 from which the hardware device 100 may still communicate with the trusted AP 210. Therefore, a hardware device 100 within the trusted zone 202 is able to detect wireless signals from the trusted AP 210 while a hardware device 100 outside the trusted zone 202 is unable to detect wireless signals from the trusted AP 210.

As discussed above, when the hardware device 100 is located outside of the trusted zone 202, any data stored on the storage device 102 may become at least partially inaccessible. In one implementation, when the hardware device 100 is outside the trusted zone 202, access to data on the storage device 102 may become limited to non-sensitive or non-confidential data. In another implementation, sensitive or confidential data may become password-protected when the hardware device 100 is outside the trusted zone 202.

In other implementations of the invention, if the hardware device 100 is outside the trusted zone 202, all data stored on the storage device 102 may become completely inaccessible and/or the hardware device 100 may become inoperable. In one implementation, the storage device 102 may shut down when the hardware device 100 is outside the trusted zone 202. With the storage device 102 off, all of the data on the storage device 102 becomes completely inaccessible and the hardware device 100 may become at least partially inoperable. In another implementation, the storage device 102 itself may become password-protected if the hardware device 100 is outside the trusted zone 202. The password may be required to enable or activate the storage device 102, and without the password, the storage device 102 may shut down. In another implementation, the hardware device 100 may shut down or otherwise become inoperable if it is located outside of the trusted zone 202. This is useful in discouraging theft of high value equipment that may not necessarily be storing sensitive or confidential data.

In further implementations, the data on the storage device 102 may become corrupted, encrypted, or destroyed if the hardware device 100 is outside of the trusted zone 202. For instance, in one implementation, if the hardware device 100 is outside the trusted zone 202, the hardware device 100 may erase at least the sensitive or confidential data on the storage device 102. In other implementations, the hardware device 100 may erase all of the data on the storage device 102. If the storage device 102 is a hard disk drive for instance, the hardware device 100 may format the hard disk drive to erase all of the data contained therein. Corruption or destruction of data on the hardware device 100, or simply making data inaccessible outside of the trusted zone 202, discourages theft of the hardware device 100 and denies access to the data on any hardware devices 100 that are indeed stolen.

In some implementations of the invention, the trusted AP 210 may utilize a security protocol to protect information transmitted between the trusted AP 210 and the hardware device 100. The use of a security protocol may also confirm for the hardware device 100 that a detected WLAN is the trusted WLAN 208 and not simply a foreign WLAN that has the same identifier as the trusted WLAN 208. In one implementation, the security protocol may use a key that is stored in both the trusted AP 210 and the hardware device 100. When the hardware device 100 detects what it believes to be the trusted WLAN 208, the hardware device 100 or the trusted AP 210 may confirm that they are both storing the same key. If the keys match, the hardware device 100 has confirmation that it has detected the trusted WLAN 208.

In one implementation, for example, the trusted AP 210 may use Wired Equivalent Privacy (WEP) to encrypt communications between it and the hardware device 100. WEP is designed to provide a level of security that is similar to a wired local area network (LAN). WEP provides security by encrypting data over the wireless signals so that it is protected as it is transmitted between the trusted AP 210 and the hardware device 100.

In some implementations, the trusted AP 210 employs a WEP security protocol using a 64-bit or a 128-bit encryption level. In one implementation, a 64-bit encryption level is used and a 13-character hexadecimal key is chosen for the encryption key. In another implementation, a 128-bit encryption level is used and a 26-character hexadecimal key is chosen. In general, a user or system administrator sets the encryption level and assigns the encryption key. The encryption key may be established and stored in the trusted AP 210 and in one or more hardware devices 100 that are authorized to be in communication with the trusted AP 210. Accordingly, if the trusted AP 210 is using the WEP security protocol, the hardware device 100 will only be able to connect to the trusted AP 210 if both the hardware device 100 and the trusted AP 210 are using the same encryption key.

When the hardware device 100 is within the trusted zone 202, it will be able to connect to the trusted AP 210 using the encryption key. If, however, the hardware device 100 is removed from the trusted zone 202, it will no longer detect a AP that uses the correct encryption key. The hardware device 100 will then recognize it is outside of the trusted zone 202 and can take the appropriate actions necessary to either secure the data or make itself inoperable. Even if the hardware device 100 detects a foreign AP that uses the same SSID or other identifier as the trusted AP 210, because the foreign AP will not have the correct encryption key, the hardware device 100 will be unable to connect to the foreign AP and will still recognize that it is outside of the trusted zone 202.

In yet another implementation, the security protocol may utilize a first key and a second key, such as a private and public key pair, both of which are stored in each of the trusted AP 210 and the hardware device 100. When the hardware device 100 detects what it believes to be the trusted WLAN 208, the hardware device 100 may transmit the first key to the trusted AP 210. If the first key matches what is stored in the trusted AP 210, the trusted AP 210 may transmit the second key to the hardware device 100. If the second key matches what is stored in the hardware device 100, the hardware device 100 has confirmation that it has indeed detected the trusted WLAN 208. Either one or both of the keys may be encrypted before transmission.

In another implementation, a Trusted Platform Module (TPM) may be used to secure communications between the hardware device 100 and the trusted AP 210. For instance, an additional chip that can be included within the hardware device 100 to permit some trusted computing features. In one implementation, the LaGrand Technology Trusted Platform Module, developed by Intel Corporation, may be used. The LaGrand Technology TPM may secure the certificate (or key) used to encrypt and identify the trusted AP 210. The TPM provides an environment secure from physical and electrical attack so that the key cannot be read from the stolen equipment with the intention of faking a trusted AP 210.

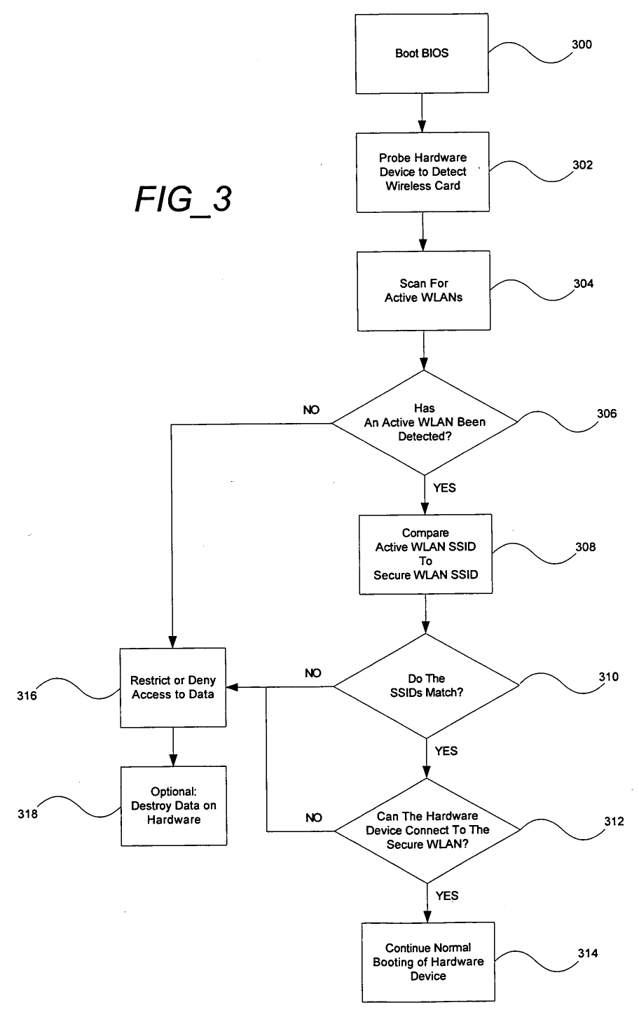

FIG. 3 is a method, according to an implementation of the invention, for the hardware device 100 to secure itself upon start-up. The hardware device 100 executes a Basic Input/Output System (BIOS) routine when it is powered on (reference numeral 300). The hardware device 100 may probe itself to detect the presence of the wireless card 104 (302). The BIOS may include one or more instructions to cause the hardware device 100 to perform this self-probe. In another implementation, the BIOS may further include instructions to cause the hardware device 100 to probe the wireless card 104 to detect the antenna 106 as well.

Once the wireless card 104 is detected, the hardware device 100 uses the wireless card 104 to scan for active WLANs (304). An active WLAN is any wireless local area network that is within range of the antenna 106. An active WLAN may or may not be the trusted WLAN 208. For example, if the hardware device 100 is stolen and moved to a location far from the trusted zone 202, the hardware device 100 may still detect one or more active WLANs. These active WLANs may simply be foreign WLANs in use by other businesses or people. The hardware device 100 may detect zero, one, or multiple active WLANs. In one implementation, the instructions to scan for active WLANs may be included as part of the BIOS. In another implementation, software that is configured to run at start-up may be used to scan for the active WLANs.

The hardware device 100 may detect an active WLAN by capturing and reading its broadcast identifier. For instance, in some implementations, the hardware device 100 may capture and read the broadcast SSID for an active WLAN. The SSID can generally be read in plain text from the header of a packet. In other implementations, the hardware device 100 may detect an active WLAN using other information that is broadcast by its corresponding AP. This information may include a security key, a network name, or a customary signal strength for that locale.

Next, the hardware device 100 determines whether it has indeed detected one or more active WLANs (306). If an active WLAN cannot be detected, the hardware device 100 employs a method to restrict or deny access to the data on the storage device 102 (316). For example, the hardware device 100 may continue booting up but access to sensitive or confidential data may become restricted. This data may become password protected or may become completely inaccessible. Alternately, the hardware device 100 may immediately shut down, denying further access to the operating system and rendering the hardware device 100 inoperable. In further implementations, the hardware device 100 may corrupt, encrypt, or destroy data on the storage device 102 (318). In some implementations, the hardware device 100 may become inoperable if an active WLAN cannot be detected. The hardware device 100 may shut down or it may request a password to remain operable.

If one or more active WLANs are detected, the hardware device 100 compares the SSID or other identifier for each active WLAN to the SSID or other identifier for the trusted WLAN 208 (308). As discussed above, the SSID or other identifier for the trusted WLAN 208 may have been previously stored on the hardware device 100 (e.g., in the storage device 102 or in electronic media within the hardware device 100 such as a flash memory or an EEPROM). The hardware device 100 may retrieve the identifier for the trusted WLAN 208 from storage and compare it to the identifier for each detected active WLAN.

After comparing the SSID or other identifier for the trusted WLAN 208 to the SSID or other identifier for each detected active WLAN, the hardware device 100 determines whether or not there is at least one match (310). If there are no matches, the hardware device 100 concludes that it has not found the trusted WLAN 208. As described above, the hardware device 100 employs a method to restrict or deny access to the data on the storage device 102 (316). In further implementations, the hardware device 100 may corrupt, encrypt, or destroy data on the storage device 102 (318). In some implementations, the hardware device 100 may become inoperable if the hardware device 100 concludes that it has not found the trusted WLAN 208. The hardware device 100 may shut down or it may request a password to remain operable.

If a match is found, the hardware device 100 may attempt to connect to the active WLAN that has the matching identifier (312). This may be done to authenticate the active WLAN and verify that the hardware device has not detected a foreign WLAN that is simply using the same SSID or other identifier as the trusted WLAN 208. In an implementation, the trusted WLAN 208 uses a security protocol such as WEP, so the trusted WLAN 208 and the hardware device 100 will have identical encryption keys. If the active WLAN with the matching identifier is indeed the trusted WLAN 208, it will have this encryption key, thereby allowing the hardware device 100 to connect to the active WLAN. Accordingly, for the hardware device 100 to successfully connect to the active WLAN, the active WLAN must have 1) the correct SSID or other identifier, and 2) the correct encryption key.

If the hardware device 100 cannot connect to the active WLAN, the hardware device 100 determines that it has not found the trusted WLAN 208. The active WLAN may be a foreign WLAN that is using the same identifier as the trusted WLAN 208. The hardware device 100 may then restrict or deny access to the data on the storage device 102 (316) and/or corrupt, encrypt, or destroy data on the storage device 102 (318).

If the hardware device 100 successfully connects to the active WLAN with the matching identifier, the hardware device 100 concludes that the active WLAN is indeed the trusted WLAN 208 and normal booting of the hardware device 100 may continue (314). The hardware device 100 may allow users to access the data on the storage device 102 as it normally would in the absence of the trusted zone 202.

In further implementations, if the identifiers do not match or if the hardware device 100 cannot connect to the active WLAN, the hardware device 100 may reattempt the method described in FIG. 3 to detect the trusted WLAN 208 before restricting access to data or shutting down. The hardware device 100 may attempt an x number of retries to detect the trusted WLAN 208, and if the hardware device 100 is still unsuccessful after x attempts, it can restrict or deny access to the data at that point.

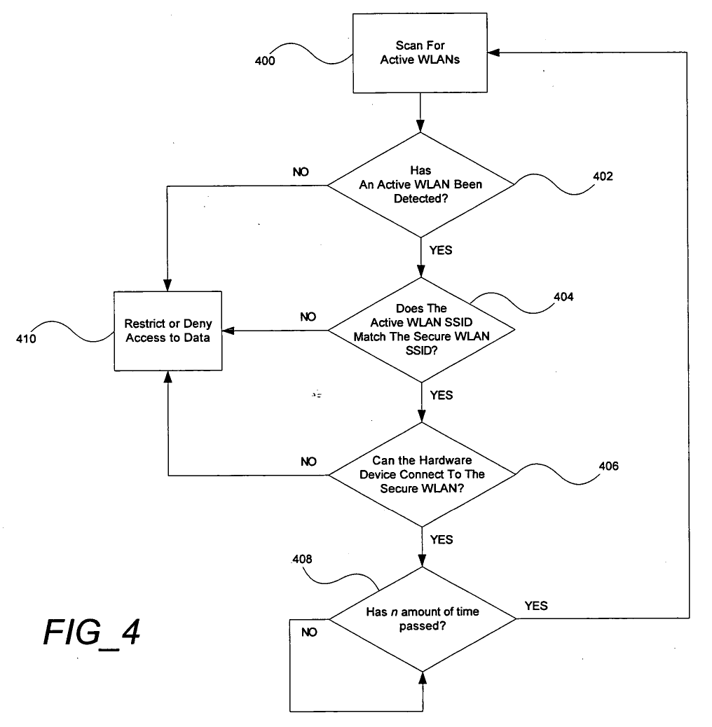

FIG. 4 is a method, according to an implementation of the invention, for the hardware device 100 to continuously monitor whether it is located within the trusted zone 202. In one implementation, the method of FIG. 3 may be used when the hardware device 100 is booted up to detect and connect to the trusted WLAN 208 while the method of FIG. 4 may be used during normal operation to prevent theft from the trusted zone 202 after the hardware device 100 is connected to the trusted WLAN 208.

As shown in FIG. 4, after the hardware device 100 has booted up and during its normal operation, the hardware device 100 scans for active WLANs (400). This process may be carried out even if the hardware device 100 believes it is already connected to the trusted WLAN 208.

The hardware device 100 then determines whether it has indeed detected one or more active WLANs (402). If an active WLAN cannot be detected, the hardware device 100 concludes that it has been removed from the trusted zone 202 and employs a method to restrict or deny access to the data on the storage device 102 (410). In further implementations, the hardware device 100 may corrupt, encrypt, or destroy data on the storage device 102.

If one or more active WLANs are detected, the hardware device 100 compares the SSID or other identifier for each active WLAN to the SSID or other identifier for the trusted WLAN 208 to find a match (404). If there are no matches, the hardware device 100 concludes that it has been removed from the trusted zone 202 and the hardware device 100 employs a method to restrict or deny access to the data on the storage device 102 (410).

If a match is found, the hardware device 100 may attempt to connect to the active WLAN that has the matching identifier (406). As described above, this may be done to authenticate the active WLAN. In an implementation, the trusted WLAN 208 uses the WEP security protocol and the hardware device 100 will be unable to connect to the active WLAN unless the active WLAN has the correct encryption key.

If the hardware device 100 cannot connect to the active WLAN, the hardware device 100 concludes that it has been removed from the trusted zone 202. In this case, the active WLAN may be a foreign WLAN that is using the same identifier as the trusted WLAN 208. The hardware device 100 then restricts or denies access to the data on the storage device 102 (410). In some implementations, the hardware device may become inoperable if an active WLAN cannot be detected.

If the hardware device 100 successfully connects to the active WLAN with the matching identifier, the hardware device 100 concludes that the active WLAN is indeed the trusted WLAN 208 and that the hardware device 100 has not been removed from the trusted zone 202. The hardware device 100 then waits for a predetermined amount of time n (408). During this time n, normal operation of the hardware device 100 may continue. The time n may be any feasible period of time, depending on how often the user wants the hardware device 100 to check its location relative to the trusted zone 202. In some implementations, the time n may range from a few milliseconds to several hours. The value of n can be adjusted based on the amount of system resources the hardware device 100 uses while carrying out the method of FIG. 4. After time n has passed, the method of FIG. 4 repeats with the hardware device scanning for active WLANs (400).

In another implementation of the invention, the method of FIG. 4 may be used without the method of FIG. 3. As such, after the hardware device 100 has booted up, the method of FIG. 4 may be carried out to initially detect and connect to the trusted WLAN 208, and then continuously repeated to monitor whether the hardware device 100 is still within the trusted zone 202.

In an implementation of the invention, the hardware device 100 may postpone scanning for the trusted WLAN 208 until a user tries to access sensitive or confidential data on the hardware device 100. This implementation allows a user to use the hardware device 100 at any location until the user attempts to access the sensitive or confidential data. At that point, the hardware device 100 can perform the methods of the invention described herein to verify that it is located within the trusted zone 202. Once that is confirmed, the hardware device 100 may grant the user access to the sensitive or confidential data.

In another implementation, a mock trusted AP 210 may be used to create the trusted zone 202. The mock trusted AP 210 does not provide full network functionality and the hardware device 100, when connected to the mock trusted AP 210, cannot access any network. Instead, the mock trusted AP 210 is simply used to broadcast an identifier for the hardware device 100 to detect and may provide enough functionality to allow the hardware device 100 to connect to the trusted AP 210. The mock trusted AP 210 may also utilize a security protocol such as WEP. The hardware device 100 may be fully functional when it is within range of the mock trusted AP 210 and may restrict access to its data when it is out of range of the mock trusted AP 210.

In another implementation, multiple secure WLANs 208 may be established in separate geographic regions. The multiple secure WLANs 208 may all use the same identifiers, or the hardware device 100 may be provided with identifiers for each of the secure WLANs 208. This will allow the hardware devices 100 to operate at several geographic regions, for example, at multiple campuses or sites for a company.

In yet another implementation of the invention, the hardware device 100 does not require being connected to the trusted AP 210 to be used. Instead, the hardware device 100 may use the wireless card 104 to simply detect the presence of the trusted WLAN 208, and once the secure WLAN is detected, the hardware device 100 may allow a user to access data contained therein without attempting to connect to the trusted AP 210. The SSID of the trusted WLAN 208 may be hidden so that only the hardware device 100 is capable of detecting it.

The invention may be implemented in one or a combination of digital electronic circuitry, hardware, firmware, and software. The invention may also be implemented as instructions stored on a machine-readable medium, which may be read and executed by a processing platform to perform the operations described herein. A machine-readable medium may include any mechanism for storing, transmitting, or receiving information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive those signals, etc.), and others.

The instructions may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program may be written in any form of programming language, including compiled or interpreted languages, and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network.

Method steps of the invention may be performed by one or more programmable processors executing a computer program to perform functions of the invention by operating on input data and generating output. Method steps may also be performed by, and apparatus of the invention may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. A method comprising:
attempting to find a predetermined wireless network;
attempting to establish a connection to the predetermined wireless network if the predetermined wireless network is found, else restricting access to a subset of data if the predetermined wireless network is not found; and
providing access to the subset of data if the connection is established, else restricting access to the subset of data if the connection is not established.

2. The method of claim 1, wherein the restricting access to the subset of data comprises completely denying access to the subset of data.

3. The method of claim 1, wherein the restricting access to the subset of data comprises requesting a password prior to providing access to the subset of data.

4. The method of claim 1, wherein the restricting access to the subset of data comprises deleting the subset of data.

5. The method of claim 1, further comprising waiting for a predetermined amount of time and then repeating the attempting to find, the attempting to establish, and the providing access.

6. The method of claim 1, wherein the attempting to find the predetermined wireless network comprises:
scanning for available SSIDs; and
comparing the available SSIDs to a predetermined SSID to find a match, wherein the predetermined wireless network is found if there is a match.

7. The method of claim 6, further comprising restricting access to the subset of data if no available SSIDs are found.

8. The method of claim 1, wherein the predetermined wireless network is implemented using radio frequency signals.

9. The method of claim 8, wherein the predetermined wireless network employs a security protocol and the connection to the predetermined wireless network is established using the security protocol.

10. The method of claim 9, wherein the security protocol comprises WEP.

11. The method of claim 10, wherein a 64-bit WEP security protocol is used.

12. The method of claim 10, wherein a 128-bit WEP security protocol is used.

13. The method of claim 1, wherein the subset of data comprises confidential data.

14. The method of claim 13, wherein the confidential data comprises medical records, financial records, credit card numbers, human resources records, personnel records, or research and development data.

15. A method comprising:
attempting to find a predetermined wireless network;
attempting to establish a connection to the predetermined wireless network if the predetermined wireless network is found, else becoming inoperable if the predetermined wireless network is not found; and
remaining operable if the connection is established, else becoming inoperable if the connection is not established.

16. The method of claim 15, wherein the becoming inoperable comprises shutting down.

17. The method of claim 15, wherein the becoming inoperable comprises requesting a password to remain operable.

18. The method of claim 15, wherein the attempting to find the predetermined wireless network comprises:
scanning for available SSIDs; and
comparing the available SSIDs to a predetermined SSID to find a match, wherein the predetermined wireless network is found if there is a match.

19. An article comprising a machine-readable medium that provides instructions, which when executed by a processing platform, cause said processing platform to perform operations comprising:
attempting to find a predetermined wireless network;
attempting to establish a connection to the predetermined wireless network if the predetermined wireless network is found, else restricting access to a subset of data if the predetermined wireless network is not found; and
providing access to the subset of data if the connection is established, else restricting access to the subset of data if the connection is not established.

20. The article of claim 19, wherein the operation of attempting to find the predetermined wireless network comprises:
scanning for available SSIDs; and
comparing the available SSIDs to a predetermined SSID to find a match, wherein the predetermined wireless network is found if there is a match.

21. The article of claim 20, wherein the operation of attempting to find the predetermined wireless network further comprises restricting access to the subset of data if no available SSIDs are found.

22. The article of claim 19, wherein the predetermined wireless network is implemented using radio frequency signals.

23. The article of claim 22, wherein the predetermined wireless network employs a security protocol and the operation of attempting to establish a connection to the predetermined wireless network comprises attempting to establish a connection to the predetermined wireless network using the security protocol.

24. The article of claim 23, wherein the security protocol comprises WEP.

25. A wireless communication system comprising:
a processor;
a memory; and
a software application, residing in the memory, comprising instructions that when executed by the processor, cause said processor to perform operations comprising:
attempting to find a predetermined wireless network;
attempting to establish a connection to the predetermined wireless network if the predetermined wireless network is found, else restricting access to a subset of data if the predetermined wireless network is not found; and
providing access to the subset of data if the connection is established, else restricting access to the subset of data if the connection is not established.

26. The system of claim 25, further comprising a wireless card and an antenna.

27. The system of claim 25, wherein the subset of data is stored on a storage device and comprises confidential data.

28. The system of claim 25, wherein the predetermined wireless network employs a WEP security protocol and the operation of attempting to establish a connection to the predetermined wireless network comprises attempting to establish a connection to the predetermined wireless network using the WEP security protocol.

29. The system of claim 25, wherein the operation of attempting to find the predetermined wireless network comprises:
scanning for available SSIDs; and
comparing the available SSIDs to a predetermined SSID to find a match, wherein the predetermined wireless network is found if there is a match.

30. The system of claim 29, wherein the operation of attempting to find the predetermined wireless network further comprises restricting access to the subset of data if no available SSIDs are found.
